(19) United States
(12) Patent Application Publication
(10) Pub. No.: US 2026/0164364 A1
(43) Pub. Date: Jun. 11, 2026

(54) RECEIVING POWER HARMONIZATION FOR A LOW RESOLUTION ARRAY

(71) Applicant: Lenovo (United States) Inc., Morrisville, NC (US)

(72) Inventors: Seyedomid TAGHIZADEH MOTLAGH, Oberursel (DE); Karthikeyan GANESAN, Nauheim (DE); Ali Ramadan ALI, Kraiburg am Inn (DE); Colin FRANK, Park Ridge, IL (US)

(21) Appl. No.: 19/181,120

(22) Filed: Apr. 16, 2025

(51) Int. Cl. H04W 52/24; H04W 52/36; H04W 56/00; H04W 74/0833

(52) U.S. Cl. CPC H04W 52/242; H04W 52/36; H04W 56/0015; H04W 74/0833

(57) ABSTRACT

Various aspects of the present disclosure relate to associating groups of time-occasions for uplink or sidelink transmissions with different receiving power levels at a receiving node (e.g., a base station or user equipment). For example, during an uplink synchronization procedure, the receiving node may define or associate transmission occasions to different received power levels or ranges (e.g., target power levels or ranges), and receive preambles at transmission occasions that remain within the receiving power level or range associated with the transmission occasion.

### TECHNICAL FIELD

The present disclosure relates to wireless communications, and more specifically to harmonizing receiving power for low resolution (LR) arrays.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that harmonize receiving power for LR arrays.

A UE for wireless communication is described. The UE may be configured to, capable of, or operable to perform one or more operations as described herein. For example, the UE may comprise at least one memory and at least one processor coupled with the at least one memory and configured to cause the UE to receive a configuration for transmission to a receiver node, wherein the configuration includes: one or more parameters associated with determining a pathloss for the transmission, a set of transmission occasions at the receiver node, and an association of a corresponding receiving (Rx) power level to each transmission occasion of the set of transmission occasions, identify a transmission occasion of the set of transmission occasions, wherein the identified transmission occasion has a receiving Rx power level associated with a target Rx power level of the UE, and transmit to the receiver node at the identified transmission occasion.

A processor for wireless communication is described. The processor may be configured to, capable of, or operable to perform one or more operations as described herein. For example, the processor may comprise at least one memory and at least one controller coupled with the at least one memory and configured to cause the processor to receive a configuration for transmission to a receiver node, wherein the configuration includes: one or more parameters associated with determining a pathloss for the transmission, a set of transmission occasions at the receiver node, and an association of a corresponding receiving (Rx) power level to each transmission occasion of the set of transmission occasions, identify a transmission occasion of the set of transmission occasions, wherein the identified transmission occasion has a receiving Rx power level associated with a target Rx power level of the UE, and transmit to the receiver node at the identified transmission occasion.

A method performed or performable by the UE is described. The method may comprise receiving a configuration for transmission to a receiver node, wherein the configuration includes: one or more parameters associated with determining a pathloss for the transmission, a set of transmission occasions at the receiver node, and an association of a corresponding receiving (Rx) power level to each transmission occasion of the set of transmission occasions, identifying a transmission occasion of the set of transmission occasions, wherein the identified transmission occasion has a receiving Rx power level associated with a target Rx power level of the UE, and transmitting to the receiver node at the identified transmission occasion.

In some implementations of the UE, processor, and method described herein, the UE, processor, and method may further be configured to, capable of, performed, performable, or operable to transmit a preamble to the receiving node via uplink (UL) physical random access channel (PRACH) at the identified transmission occasion.

In some implementations of the UE, processor, and method described herein, the UE, processor, and method may further be configured to, capable of, performed, performable, or operable to identify the transmission occasion based on its Rx power level, one or more supported Rx power levels of the UE, or a maximum transmitting (Tx) power level of the UE.

In some implementations of the UE, processor, and method described herein, each transmission occasion of the set of transmission occasions is associated with a single power level, multiple power levels, or a ratio between two adjacent power levels of a power level sequence.

In some implementations of the UE, processor, and method described herein, each transmission occasion of the set of transmission occasions is associated with a range of power levels.

In some implementations of the UE, processor, and method described herein, a range of power levels is defined as a minimum starting power value, a maximum ending power value, a difference between two power values, or a group of power values within a grid of power level ranges.

In some implementations of the UE, processor, and method described herein, the configuration includes: an indication of one or more physical layer reference signals (PL-RSs), an indication of a Tx power for the one or more PL-RSs, an indication of the transmission occasions available at the receiving node, an indication of transmission occasion parameters associated with LR status at the receiving node, and combinations thereof.

In some implementations of the UE, processor, and method described herein, the UE, processor, and method may further be configured to, capable of, performed, performable, or operable to re-transmit to the receiving node using a Tx power used during the transmission to the receiving node at the identified transmission occasion, re-transmit to the receiving node using a Tx power that is higher than a Tx power used during the transmission to the receiving node at the identified transmission occasion, or re-transmit to the receiving node using a different transmission occasion.

In some implementations of the UE, processor, and method described herein, the re-transmission is based on a number of previous failed transmissions to the receiving node.

In some implementations of the UE, processor, and method described herein, the UE, processor, and method may further be configured to, capable of, performed, performable, or operable to receive a synchronization signal block from the receiving node and determine an initial transmission occasion of the set of transmission occasions as a first transmission occasion of the set of transmission occasions.

In some implementations of the UE, processor, and method described herein, the UE, processor, and method may further be configured to, capable of, performed, performable, or operable to determine the pathloss for the transmission based on: a number of beams at the receiving node, a number of beams at the UE, and a function that is based on multiple beam-pairs among the number of beams at the receiving node and the number of beams at the UE.

In some implementations of the UE, processor, and method described herein, the pathloss is based on an average Rx power level of the beams at the receiving node.

In some implementations of the UE, processor, and method described herein, the pathloss is based on a weighted average Rx power level of the beams at the receiving node.

In some implementations of the UE, processor, and method described herein, the pathloss is based on a maximum Rx power level of the beams at the receiving node.

In some implementations of the UE, processor, and method described herein, the set of transmission occasions is associated with frequency domain mapping of the identified transmission occasion and a frequency domain resource.

In some implementations of the UE, processor, and method described herein, the identified transmission occasion is associated with a transmission occasion group and transmission occasion position.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit, to a UE, a configuration for transmission to the network entity, wherein the configuration includes: one or more parameters associated with determining a pathloss for the transmission, a set of transmission occasions, and an association of a corresponding Rx power level to each transmission occasion of the set of transmission occasions and receive a preamble from the UE and via a transmission occasion having a receiving Rx power level that is associated with a target Rx power level of the UE.

A method performed or performable by the network entity is described. The method may comprise transmitting, to a UE, a configuration for transmission to the network entity, wherein the configuration includes: one or more parameters associated with determining a pathloss for the transmission, a set of transmission occasions, and an association of a corresponding Rx power level to each transmission occasion of the set of transmission occasions and receiving a preamble from the UE and via a transmission occasion having a receiving Rx power level that is associated with a target Rx power level of the UE.

In some implementations of the network entity and method described herein, the network entity and method may further be configured to, capable of, performed, performable, or operable to transmit, to the UE, an indication of an LR status for an Rx beam or antenna array, wherein the LR status for the Rx beam or antenna array is indicated by: the Rx beam or antenna array being associated with a radio chain having an LR analog-to-digital converter (ADC), the Rx beam or antenna array being associated with an array of radio chains having LR ADCs, or the Rx beam or antenna array having a reduced maximum achievable signal to noise ratio (SNR).

### BRIEF DESCRIPTION OF THE DRAWINGS

FIG. 1 illustrates an example of a wireless communications system in accordance with aspects of the present disclosure.

FIG. 2 illustrates example PRACH occasions for a base station in accordance with aspects of the present disclosure.

FIGS. 3A-3B illustrate an association of PRACH occasions to corresponding receiving power levels in accordance with aspects of the present disclosure.

FIG. 4 illustrates an example messaging flow during an initial access procedure in accordance with aspects of the present disclosure.

FIG. 5 illustrates a selection of a candidate PRACH occasion in accordance with aspects of the present disclosure.

FIG. 6 illustrates an example pathloss determination in accordance with aspects of the present disclosure.

FIG. 7 illustrates another example pathloss determination in accordance with aspects of the present disclosure.

FIG. 8 illustrates another example pathloss determination in accordance with aspects of the present disclosure.

FIG. 9 illustrates another example pathloss determination in accordance with aspects of the present disclosure.

FIGS. 10A-10B illustrate example associations of receiving target power levels to PRACH occasions in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of an NE in accordance with aspects of the present disclosure.

FIG. 14 illustrates a flowchart of a method performed by a UE or NE in accordance with aspects of the present disclosure.

FIG. 15 illustrates a flowchart of a method performed by an NE in accordance with aspects of the present disclosure.

### DETAILED DESCRIPTION

The present disclosure relates to methods, apparatuses, and systems that harmonize receiving power at LR antenna arrays. An LR array may include low resolution digital-to-analog converters (DACs) and analog-to-digital converters (ADCs), which are low in complexity and cost and may facilitate reduced link and/or energy consumption at an antenna array, such as an array at a base station or other NE.

A digital LR receiving array may enable a high spatial processing capability in a baseband, which can enhance a base station in a variety of ways, such as fast receiving/transmitting (Rx/Tx) determinations, increased contention avoidance of uplink PRACH transmission and/or uplink multiplexing, and so on. However, the use of LR components in arrays may introduce issues associated with channel estimation of wireless links, beam determination and/or management, link adaption, and so on, due to non-linear LR quantization effects that may be introduced by using the LR components.

A base station (e.g., employing a multiple-input multiple-output (MIMO) array) may exhibit quantization distortion using LR components (e.g., LR radios). For example, a radio chain associated with an analog array beamforming may exhibit quantization distortion due to a quantized Tx/Rx signal, which can cause a different or degraded beam measurement quality at the radio chain. As another example, a Tx/Rx beam associated with an array of radio chains (e.g., via digital Tx/Rx beamforming) may exhibit a degraded spatial signature due to a reduced beam quality, such as an increased sidelobe or degraded beamwidth/alignment.

Further, the co-location of multiple uplink transmissions at a shared time-occasion towards an LR Rx array may reduce the dynamic range of the base station (e.g., as a receiver or receiving node), due to the quantization distortion of the Rx signal power. For example, when a base station antenna receives two signals with power levels (P₁, P₂), the power levels may be jointly quantized, and the quantization distortion impacts the reception of both signals at the same time. Given a certain number of quantization bits (b_{Q}), the added quantization distortion may have a power of approximately P_{Q}[dB]=10*log₁₀(P₁+P₂)−6.22b_{Q}, which impacts the reception of both signals. Thus, when the second signal is received at a larger power level compared to the power level that received the first signal, the first signal may be impacted/buried by the quantization distortion of the larger signal. This impact/burying of the signal may hinder the proper reception/detection of the first signal by the LR receiver array.

The technology described herein may resolve such issues during uplink PRACH configuration and transmission, where transmission occasions associated with lower power levels may be buried or impacted by the quantization or noise of the transmission occasions associated with higher power levels. The technology may update transmission occasions (e.g., RACH occasions) and associated uplink PRACH transmissions to enable reception of multiple users with a minimal dynamic range of power levels (e.g., power levels of the received signal power) at an LR receiving array.

For example, the technology may facilitate the association of groups of time-occasions for uplink or sidelink transmissions with different receiving power levels at a receiving node (e.g., a base station or UE). During an uplink synchronization or initial accesss procedure (e.g., following open-loop power control), the receiving node may define or associate PRACH occasions to different received power levels or ranges (e.g., target power levels or ranges). For example, the base station may receive a PRACH preamble at a transmission occasion K that remains within the receiving power level or range associated with the transmission occasion K.

Thus, the technology may facilitate the utilization of LR arrays by harmonizing the receiving power at the arrays and enabling use of transmission occasions at different power levels or ranges, among other benefits.

Aspects of the present disclosure are described in the context of a wireless communications system.

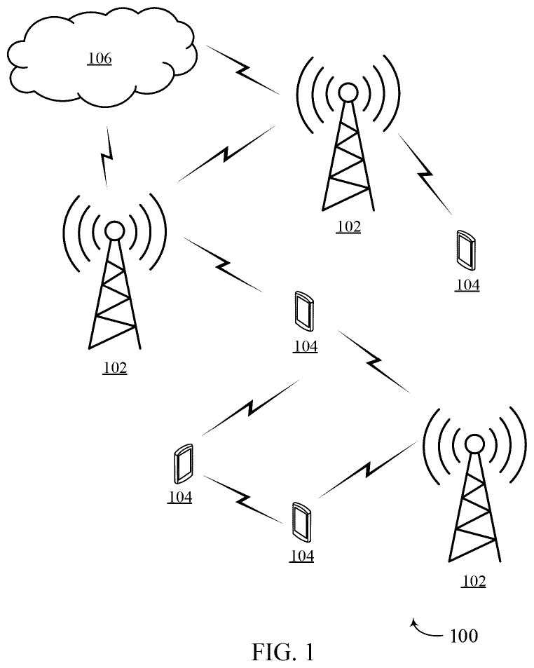

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the technology enables the utilization of transmission occasions (e.g., PRACH occasions) having different power levels or ranges at an LR array during initial access and other procedures. A base station (e.g., a gNB) may receive a PRACH transmission from one or more UEs (e.g., the UE 104) via an LR reception array (or one or more Rx beams associated with an LR condition). An LR reception status of the gNB may be configured or associated with a set of transmission occasions (e.g., PRACH occasions) or PRACH configuration parameters.

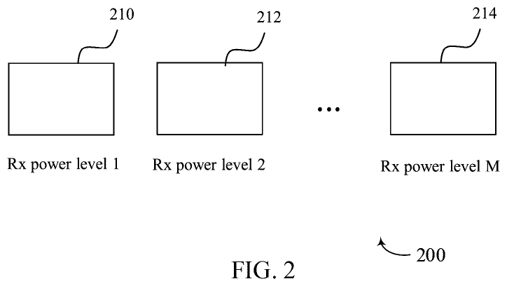

For example, the PRACH occasions are associated with a target received (or receiving) power level at the gNB, where each PRACH occasion has a configured/pre-defined target Rx power level or target Rx power range that is permissible at the gNB and associated with the transmission of the PRACH by a UE. FIG. 2 illustrates example PRACH occasions 200 for a base station in accordance with aspects of the present disclosure. Each of the PRACH occasions 200, in a time domain, are associated with a different or unique Rx power level. For example, PRACH occasion 210 is associated with an Rx power level 1, PRACH occasion 212 is associated with an Rx power level 2, and PRACH occasion 214 (e.g., any subsequent PRACH occasion M) is associated with an Rx power level M.

In some examples, a PRACH occasion may be associated with an Rx power level that is represented as one target power value (e.g., a PRACH occasion #k is associated with a power value Pk as indicated/configured/pre-configured). Thus, a set of Rx power values may be defined via one power levels, a number of power levels, a distance, difference, or ratio between two adjacent power levels (e.g., a starting power level of P₀ and distance of $\Delta P$ between each two power levels constructing a power level sequence of {P₀, P₀+ΔP, P₀+ΔP, . . . , P₀+(M−1)ΔP}, where Mis a number of PRACH occasions for which different power levels are provisioned), and so on. In some cases, a starting power level of P₀ and a ratio of A between each two adjacent power levels may be indicated by constructing the power level sequence of {P₀, P₀Δ, P₀Δ², . . . , P₀Δ(M−1)}, where Mis the number of PRACH occasions for which different power levels are provisioned.

In some examples, a PRACH occasion may be associated with an Rx power range, which defines or represents a permissible received power level from a PRACH transmission. A power range may be defined or indicated via a minimum/starting power value of the range, a maximum/end power value of the range, a distance/difference between minimum and maximum permissible power values of the same range, a group of power values defining a grid of power ranges, and so on.

For example, a starting boundary of P₀ (e.g., for the permissible Rx power level at a PRACH occasion) and a distance of $\Delta P$ between each two boundaries may define or construct a power range sequence of {[P₀, P₀+ΔP], [P₀+ΔP, P₀+2ΔP], . . . , [P₀+(M−1)ΔP]}, where Mis the number of PRACH occasions for which different power levels are provisioned.

As another example, a starting boundary of P₀ and a ratio of $\Delta $ between two adjacent boundaries may define or construct the power range sequence of {[P₀, P₀Δ], [P₀ΔP, P₀Δ²], . . . , [P₀Δ^{(M-2)}, P₀ Δ^{(M-1)}]}, where Mis the number of PRACH occasions for which different power levels are provisioned.

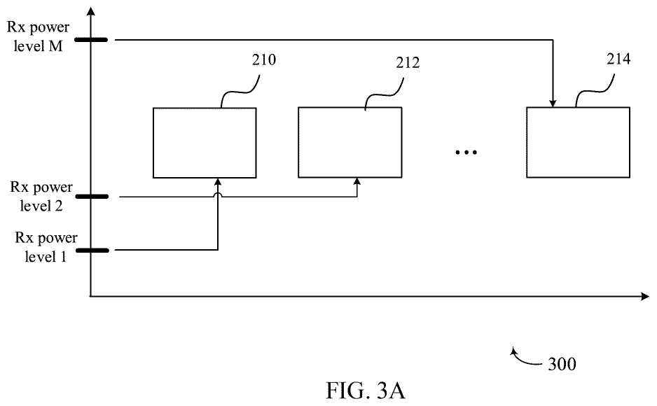

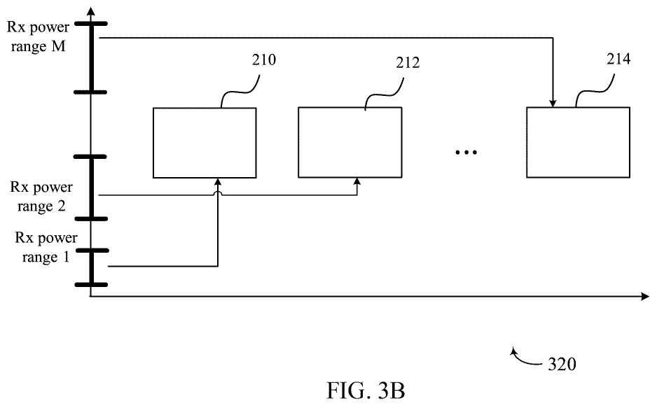

FIGS. 3A-3B illustrate an association of PRACH occasions to corresponding receiving power levels in accordance with aspects of the present disclosure. As depicted in FIG. 3A, the PRACH occasion 210 is associated with an Rx power level 1, the PRACH occasion 212 is associated with an Rx power level 2 (e.g., a power level larger than the power level 1), and the PRACH occasion 214 is associated with an Rx power level M (e.g., a highest relative power level for the set of PRACH occasions and/or the power level for the Mth PRACH occasion of the set of PRACH occasions).

FIG. 3B depicts an association of PRACH occasions to power ranges. For example, the PRACH occasion 210 is associated with an Rx power range 1, the PRACH occasion 212 is associated with an Rx power range 2 (e.g., a power range larger than the power range 1), and the PRACH occasion 214 is associated with an Rx power range M (e.g., a highest relative power range for the set of PRACH occasions and/or the power range for the Mth PRACH occasion of the set of PRACH occasions). In some cases, each power range may be similar in scale (e.g., covering a similar range of power levels) or different in the size or scale of the range.

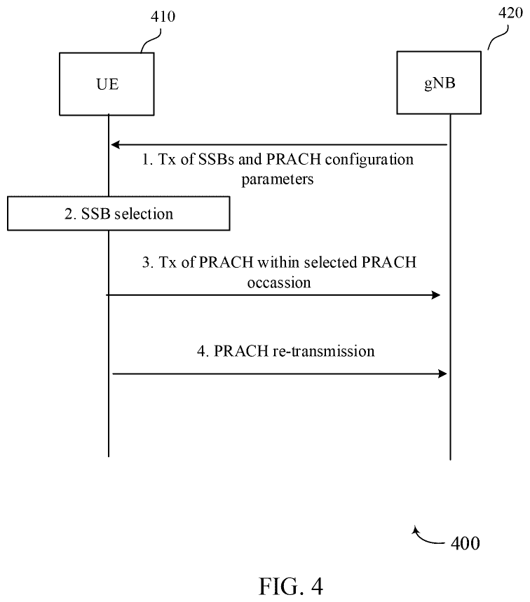

As described herein, the UE 104 may utilize the set of PRACH occasions during initial access procedures (e.g., random access). FIG. 4 illustrates an example messaging flow 400 during an initial access procedure in accordance with aspects of the present disclosure. The messaging flow 400 may implement various aspects of the present disclosure described herein. For example, the messaging flow 400 may include a UE 410 and a gNB 420, which may be examples of UEs and gNBs, as described herein. In the following description of the messaging flow 400, the operations between the UE 410 and the gNB 420 may be performed in different orders or at different times. Some operations may also be omitted, or other operations may be added. Although the UE 410 and the gNB 420 are shown performing the operations of the messaging flow 400, some aspects of some operations may also be performed by other entities of the messaging flow 400 or by entities that are not shown in the messaging flow 400, or any combination thereof.

At step 1, the gNB 420 (e.g., a receiving node) transmits synchronization signal blocks (SSBs) and PRACH configuration parameters. For example, the gNB 420 may transmit the SSB (or physical broadcast channel (PBCH) and configuration information used by the UE 410 when determining the PRACH occasion and the UE Tx power for PRACH transmission to the gNB 420. The configuration information (e.g., PRACH configuration parameters) may include:

An indication of one or more pathloss reference signals (PL-RSs), which may be interpreted/defined as a RS used for PL measurement/calculation at the UE 410 and/or for which the Tx power level is defined/configured for use by the UE 410 when determining an expected PL between transmission of the PRACH and the received power at the gNB 420. In some cases, the UE 410 uses the PL-RS to determine that the received power at the gNB 420 may be the SSB/PBCH determined by the UE 410 as the best SSB/PBCH and the Tx beam used for transmission of the PRACH is a corresponding Tx beam to an Rx filter/beam used by the UE 410 to receive the best/selected SSB/PBCH;

An indication/information of a transmission power of a PL-RS, such as a pre-configured value or a value configured/indicated by the gNB 420 to the UE 410 as part of a broadcast information transmission;

An indication of the PRACH occasions, including the time occasions at which the PRACH can be transmitted by the UE 410;

An indication of a configuration, PRACH occasion, and/or PRACH transmission parameters, which are associated with an LR reception status at the gNB 420;

Information of mapping PRACH occasions to a permissible/acceptable Rx power at the gNB 420. For example, the UE 410 may interpret the indicated mapping associated with an LR Rx status of the gNB 420 when the UE 410 is indicated (e.g., prior to the PRACH transmission/determination by the UE 410) or determined (e.g., the UE 410 selected autonomously or based on an indicated configuration) that the PRACH transmission will be associated with the LR reception at the gNB; and so on.

At step 2, the UE 410 performs SSB selection. For example, based on the received SSB/PBCH and the configuration information, the UE 410 may select a best SSB, measure the received signal power of the indicated one or more PL-RS transmissions, determine the PL corresponding to the UE 410 and the gNB 420, (e.g., associated with the Tx beam of the UE 410 (e.g., determined to be used for the PRACH transmission) and the at the reception beam of the gNB 420), determine the supported PRACH occasions (e.g., the PRACH occasion at which the UE transmission power is sufficient to generate the required Rx target power level at the gNB 420), and determine a corresponding Tx power level of the UE 410 to be used for PRACH transmission.

At step 3, the UE 410 transmits the PRACH (e.g., a PRACH preamble) within a selected PRACH occasion. For example, the UE 410 transmits the PRACH based on the determined PRACH occasion, sequence, Tx beam, Tx power at the UE 410, and so on.

In some cases, when the UE 410 determines no response from the gNB 420 (e.g., a timer initiated upon transmission of the PRACH exceeds an indicated or pre-configured maximum time without receiving a response to the transmitted PRACH), the

UE 410, at step 4, performs a PRACH re-transmission. For example, the UE 410 may perform the re-transmission as follows:

In some cases, the UE 410 repeats the PRACH transmission with the same UE Tx power (e.g., and, optionally, the same Tx beam and PRACH occasion/sequence/configuration). In some cases, the UE 410 performs the re-transmission for an indicated or pre-defined number of times before the UE Tx power is increased for a next PRACH transmission. In some cases, the UE 410 determines that a UE Tx power level larger than the used Tx power is not supported by the UE 410 (e.g., exceeds the maximum UE Tx power). In some cases, the UE 410 determines that the used PRACH occasion (and the utilized Tx UE power at the PRACH occasion) corresponds to the last or second to last supported Rx power level at the gNB 420. Thus, the UE 410 determines that a higher UE Tx power may result in an unsupported (e.g., no provisioned PRACH occasion), Rx power level at the gNB 420.

In some cases, the UE 410 repeats the PRACH transmission with an increased transmission power (and, optionally, the same Tx beam and PRACH occasion/sequence/configuration). In some cases, the UE 410 determines a next value of the UE transmission power according to an indicated or pre-configured delta/difference/ratio/value for the power increase. In some cases, the next transmission power value is determined based on selecting a power value from an indicated or pre-defined table with an increased index (e.g., the power value of the table corresponding to index i+l instead of i). In some cases, upon determining the increased UE Tx power, the UE 410 determines the PRACH transmission occasion (e.g., to correspond to the same or to the next level of the associated Rx power at the gNB 420). In some cases, the UE 410 determines next transmission power value based on a selection of a next level Rx power value at the gNB 420 (e.g., after repeating the re-transmission of the same UE Tx power or re-transmission at the same PRACH occasion for an indicated or pre-defined number of times) and determines the corresponding UE Tx power level based on the selected Rx power level at the gNB 420.

In some cases, the UE 410 performs the PRACH transmission with a different configuration that is associated with high resolution (HR) reception of the gNB 420 (e.g., including a different set of PRACH occasions and determining separate/different parameter sets of a PRACH Tx beam, Tx power, PRACH occasion, and so on).

In some examples, upon reception of the SSB/PBCH and associated configuration information, the UE 410 may determine a set or range of candidate PRACH occasions, Rx target power at the gNB 420 (e.g., based on a calculated pathloss), the target power levels of different PRACH occasions (e.g., as pre-configured or configured by the gNB 420), and/or the UE Tx power capability (e.g., a maximum transmission power of the UE).

In some examples, the UE 410 may select a first-time occasion of a set of candidate/feasible PRACH occasions as an initial PRACH occasion. In some examples, the UE 410 may determine a PRACH occasion corresponding to the minimum Rx power level or the minimum Tx power level to be the initial PRACH occasion (e.g., the occasion for the first transmission of the PRACH). In some cases, the UE 410 randomly selects an initial PRACH occasion from the set of candidate/feasible PRACH occasions. For example, the UE 410 may randomly select the initial PRACH occasion with a configured/pre-defined distribution (e.g., a distribution with a higher probability for the candidate PRACH occasions associated with a lower (Tx/Rx) power level).

Further, in some examples, the UE 410 may act or operate as the receiving node, such as by receiving sidelink communications from other UEs. Thus, as described herein, in various examples, the UE 410 or the gNB 420 may operate as the receiving node and communication or transmit messages with other UEs, base stations, and so on.

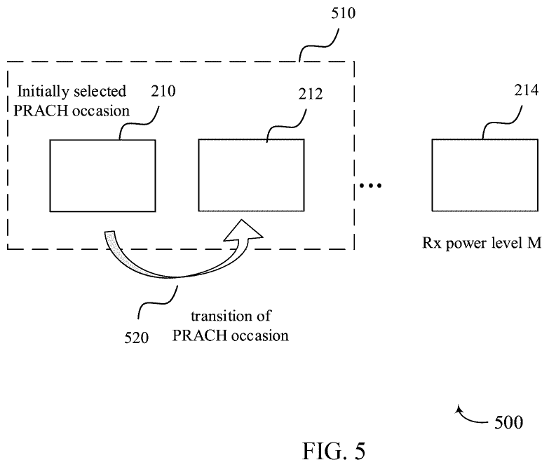

FIG. 5 illustrates a selection 500 of a candidate PRACH occasion in accordance with aspects of the present disclosure. As depicted, the UE 410 determines a set of supported/feasible PRACH occasions 510 (e.g., the PRACH occasions 210 and 212) based on a measured PL, the UE max Tx power, and/or the supported Rx power level at the different PRACH occasions. As described herein, the UE 410 selects an initial PRACH occasion (e.g., the PRACH occasion 210), and may transition between the feasible/candidate PRACH occasions 510 (e.g., to the PRACH occasion 212) for a Tx power increase during PRACH re-transmission.

In some examples, an LR status of an Rx beam or antenna array may be indicated/pre-defined as follows:

An Rx antenna/beam associated with a radio chain with a low-resolution ADC (e.g., an LR beam is generated via a summation of an analog phase rotation of received signals at different Rx antennas, where the received summation is connected to one or more radio Rx chains of the LR ADC);

An Rx antenna/beam associated with an array of radio chains with a low-resolution ADC (e.g., enabling digital Rx beamforming in a baseband via an array of Rx RF chains with LR ADCs);

An Rx antenna/beam associated with a radio chain with a reduced maximum achievable signal to noise ratio (SNR) limited by the reception quantization (e.g., ADC distortion), achievable throughput, or spectral efficiency (e.g., a supported rate per time unit and/or frequency unit);

An Rx antenna/beam associated with a reduced Rx power consumption;

An Rx antenna/beam associated with a reduced number of quantization convertor bits (e.g., with a convertor resolution below 4 bits and/or an achievable Rx SNR of an antenna below 10 dB); and so on.

In some examples, an expected Rx power at an Rx antenna/beam of a gNB (e.g., the gNB 420) may be based on a measurement of the receiver power associated with a signal (e.g., SSB, demodulation reference signal (DMRS), PBCH, channel state information RS (CSI-RS), and so on) and the transmission power associated with the signal (e.g., indicated by the configuration information).

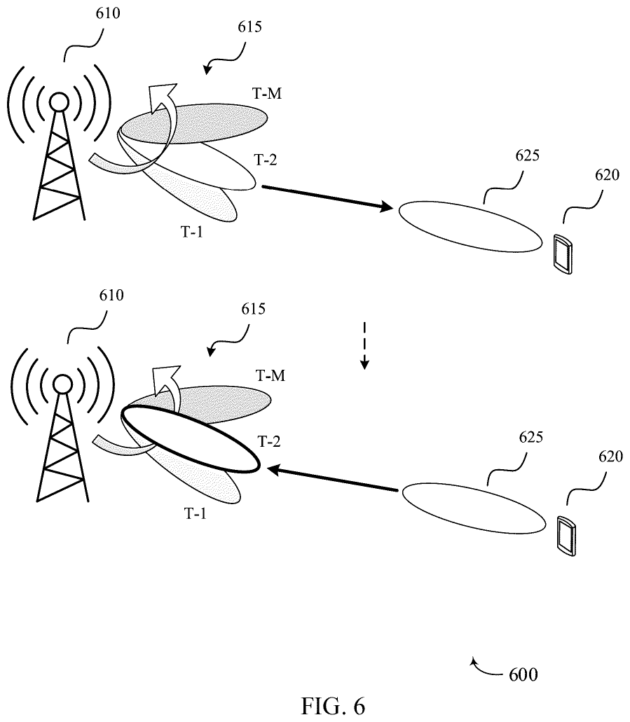

In some examples, the pathloss (e.g., a determination of the Rx target power at the gNB 420 and/or the PRACH transmission occasion) may be determined in a number of ways (e.g., as depicted in FIGS. 6-9 and described herein). For example, the pathloss may be associated with a Tx beam/transmission radiation pattern at the UE 410 and an Rx beam or antenna/radiation pattern at the gNB 420. The Tx/Rx beams or radiation patterns associated with the pathloss of a propagation link (e.g., from the UE PRACH transmission and the Rx antennas at the gNB 420) may be based on signals measured by the UE 410.

FIG. 6 illustrates an example pathloss determination 600 in accordance with aspects of the present disclosure.

A UE 620 receives and measures the downlink SSB/PBCH/DMRS 615 from a gNB 610 and selects an SSB/PBCH (e.g., the SSB/PBCH received with a highest RSRP or the first detected SSB/PBCH). The UE 620 utilizes a Tx beam 625 for transmission of a PRACH corresponding to a best Rx beam (e.g., T−2) by which the selected SSB/PBCH is measured/detected. The gNB 610 target Rx power may be defined based on the Rx beam corresponding to the transmission of the selected SSB/PBCH. In some cases, a pathloss is determined between the UE Tx 625 (utilizing the Rx beam associated with the selected SSB/PBCH) and assuming the Rx beam at the gNB 610 corresponding to the used Tx beam (at the gNB 610) for transmission of the selected SSB/PBCH. As an example, the pathloss may be defined as:

$$P {L}_{k , i} = SelectedSSBTxPowe {r}_{k} - R e c e i vedUERSRPofSelectedSS {B}_{k} ( i ) .$$

Where PLₖᵢ denotes the path loss between the gNB 610 and the UE 620 associated with the beam k of the gNB 610 and beam i of the UE 620 and the ReceivedUERSRPofSelectedSSBₖ(i) denotes the measured power (e.g., RSRP) associated with the (transmission) beam k and the (reception) beam i. Further, the index k represents the beam by which the SSB/PBCH is transmitted and the index i indicates the beam at which the UE 620 receives/measures the selected SSB/PBCH and the beam i corresponds to the used uplink beam for PRACH transmission.

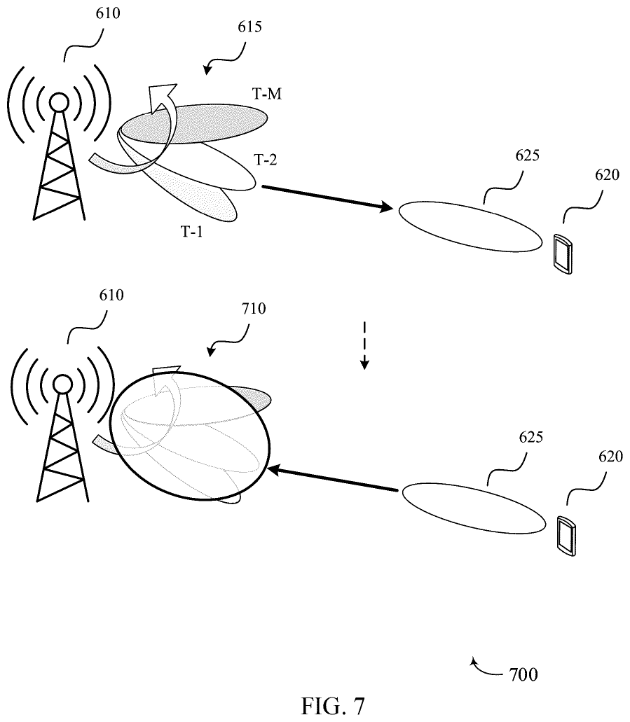

FIG. 7 illustrates another example pathloss determination 700 in accordance with aspects of the present disclosure. The UE 620 receives and measures the DL SSB/PBCH/DMRS 615 and selects an SSB/PBCH. The UE 620 utilizes a Tx beam for transmission of the PRACH corresponding to the best Rx beam by which the selected SSB/PBCH is measured/detected. In some cases, the gNB reception may utilize a different array/array type/array architecture (e.g., while the SSB/PBCH are transmitted via an HR Tx array, the reception of the PRACH may be performed via a receiver array/antenna/beam associated with an LR status). Thus, the gNB target Rx power may be defined based on the Rx beam not directly corresponding to the transmission of the selected SSB/PBCH. The gNB target Rx power may be defined based on the Rx beam corresponding to two or more of the SSB (or other RS/signal) beams 710, or to a weighted combination of the SSB (or other RS/signal) beams 710.

The pathloss may be determined between the UE Tx (e.g., utilizing the Rx beam associated with the selected SSB/PBCH) and based on the Rx beam at the gNB 610 corresponding to a weighted combination of the beams/radiation patterns for transmission of the SSBs 710. In some cases, where the Rx beam/radiation pattern at the gNB 610 corresponds to the average of the Tx beams of the SSBs 710, the pathloss may be defined as:

$$P {L}_{k , i} = \frac{1}{\vert 𝒮 \vert} {\sum }_{j ∈ 𝒮} S S B T x P o w e {r}_{j} - R e c e i vedUERSRPofSS {B}_{j} ( i ) ,$$

Where the set S denotes a set of beams to which the Rx radiation pattern/beam k of the gNB corresponds (e.g., a set of the Tx SSB gNB beams that corresponds to an LR Rx beam) and index i defines the beam used to transmit towards the gNB 610 (e.g., at which the PL is measured). As described herein, the beam i corresponds to the (best) Rx beam at the UE 620 at which the selected SSB/PBCH is measured.

In some cases, where the Rx beam/radiation pattern at the gNB 610 corresponds to the maximum of the Tx beams of the SSBs 710, the pathloss may be defined as:

$$P {L}_{k , i} = {max}_{j ∈ 𝒮} \{ S S B T x P o w e {r}_{j} - R e c e i vedUERSRPofSS {B}_{j} ( i ) \} .$$

In some cases, where the Rx beam/radiation pattern at the gNB 610 corresponds to the minimum of the Tx beams of the SSBs 710, the pathloss may be defined as:

$$P {L}_{k , i} = {min}_{j ∈ 𝒮} \{ S S B T x P o w e r - R e c e i vedUERSRPofSS {B}_{j} ( i ) \} .$$

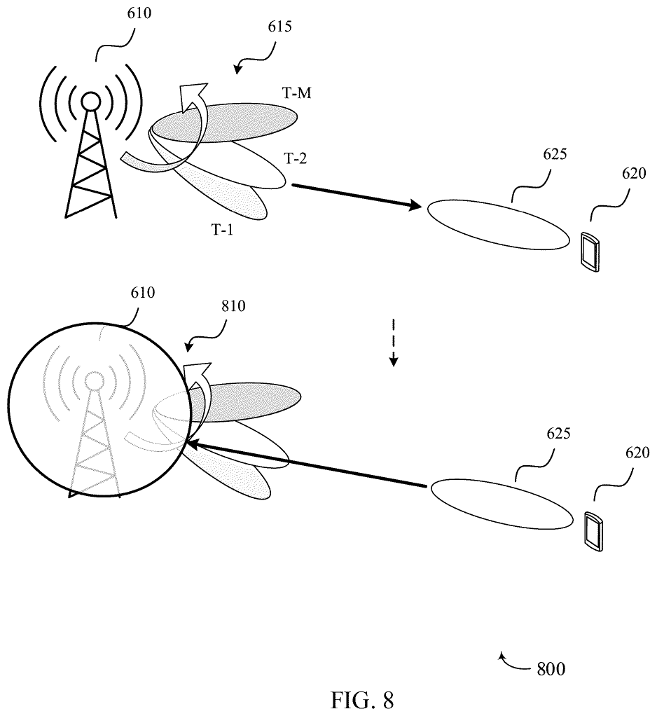

FIG. 8 illustrates another example pathloss determination 800 in accordance with aspects of the present disclosure. The UE 620 receives and measures the DL SSB/PBCH/DMRS 615 and selects an SSB/PBCH. The UE 620 utilizes a Tx beam for transmission of the PRACH corresponding to the best Rx beam by which the selected SSB/PBCH is measured/detected. In some cases, the gNB reception may utilize a different array/array type/array architecture (e.g., while the SSB/PBCH are transmitted via an HR Tx array, the reception of the PRACH may be performed via a receiver array/antenna/beam associated with an LR status).

For example, the gNB target Rx power may correspond to an isotropic or omni-directional pattern 810 at the SSB (or other RS/signal) beams, or to a combination of all the measured SSB/PBCHs (or other RS/signal) beams. The pathloss may be determined between the UE Tx (utilizing the Rx beam associated with the selected SSB/PBCH) and the Rx beam at the gNB 610 corresponding to all of the DL SSB/PBCH signals (e.g., the pattern 810).

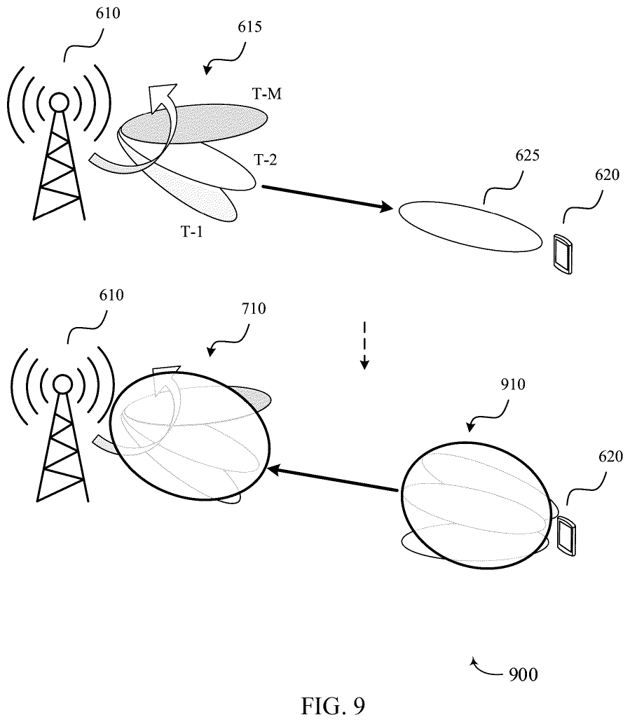

FIG. 9 illustrates another example pathloss determination 900 in accordance with aspects of the present disclosure. The UE 620 receives and measures the DL SSB/PBCH/DMRS 615 over different available Rx UE beams 910. Subsequently, the UE 620 utilizes a Tx beam for transmission of the PRACH corresponding to a combination of the available Rx beams (e.g., where the UE Tx beam radiation pattern is a weighted combination of the multiple UE Rx beams).

The pathloss may be determined between the UE Tx beam (e.g., corresponding to a weighted combination of the UE Rx beams) and based on the Rx beam at the gNB corresponding to a weighted combination of the beams carrying DL RS transmissions. For example, the pathloss may be defined as:

$$P {L}_{k , i} = \frac{1}{\vert 𝒵 \vert} \frac{1}{\vert 𝒮 \vert} {\sum }_{z ∈ 𝒵} {\sum }_{j ∈ 𝒮} \{ SSBTxPowe {r}_{j} - ReceivedUERSRPofSS {B}_{j} ( z ) \} {W}_{zj} .$$

Where Z is the set of the beams corresponding to the UE beam for which the PL is to be calculated, and W_{zj} is a weight given to the beam pair (z, j) for construction of the beam pair (i, k).

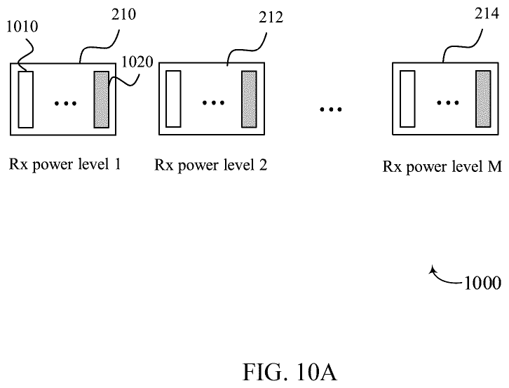

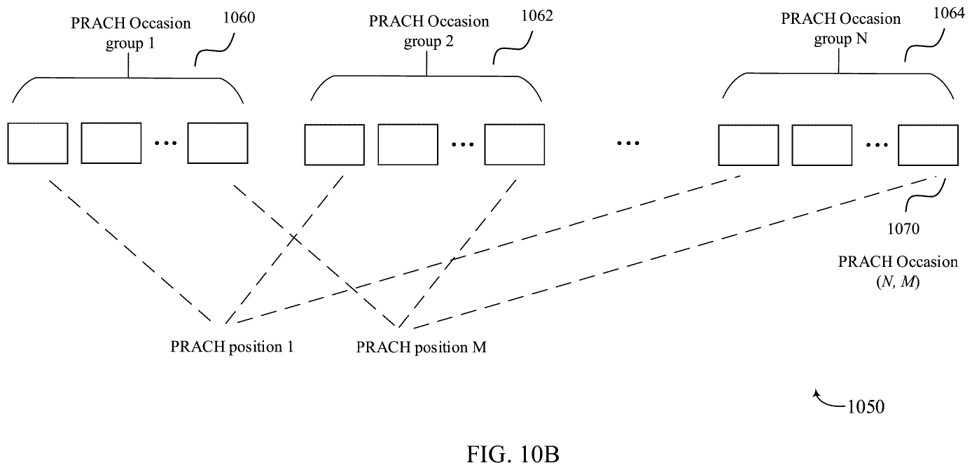

In some examples, PRACH transmission parameters (e.g., the PRACH occasion, the PRACH transmission frequency resource, the PRACH transmission beam, and so on.) of the UE 410 may be jointly associated with a selected/detected SSB/PBCH and a determined Rx target power level at the gNB 420. FIGS. 10A-10B illustrate example associations of receiving target power levels to PRACH occasions in accordance with aspects of the present disclosure.

FIG. 10A depicts an association 1000 of the time-domain PRACH occasions 210, 212, 214 with a target Rx power at the gNB 420 and frequency resources over which the PRACH is transmitted to the selected SSB/PBCH. For example, there may be a one-to-one mapping between a selected SSB/PBCH index and an index of the frequency resource (e.g., each depicted subgroup 1010, 1020 is associated with a distinct SSB/PBCH index/occasion). In some cases, multiple SSB/PBCH occasions may be mapped to a single subgroup 1010, 1020 (e.g., each LSSB index may be associated with one subgroup).

In some examples, a time-domain resource (e.g., a PRACH occasion) is jointly associated with an Rx power level/range as well as an SSB/PBCH index or index set. FIG. 10B depicts an association 1050 of different Rx target power levels to different PRACH occasions and frequency domain resources, or subgroups, to different SSB/PBCH indexes or index sets. For example, different PRACH occasion groups 1060, 1062, 1064 are associated to a different Rx target power level or range, where a PRACH position (e.g., 1, 2, M) is associated with an SSB/PBCH index or SSB/PBCH index set. In some cases, a PRACH occasion group (e.g., group 1060) is associated with an SSB/PBCH index or SSB/PBCH index, where a PRACH position is associated with an Rx target power level or range. Thus, a PRACH occasion (N,M), such as a PRACH occasion 1070, may refer (e.g., jointly) to an Rx power level/range and an SSB/PBCH index or SSB/PBCH index set known at the UE 410 and at the gNB 420.

In some examples, an UL/SL transmission configuration of a physical data/control channel associated with a time-occasion may be associated with a target Rx power level at the receiver (e.g., a gNB or Rx UE). For example, the occasions associated with an Rx power level are defined/indicated/configured via a slot-format indication where the slot format includes information of an expected Rx power level at the receiver (e.g., a slot format with an UL symbol associated with a target power level X). In some cases, the indication/configuration of a target Rx power level associated with a symbol may be indicated via a dynamic configuration (e.g., via a UE-specific downlink control information (DCI) or a DCI with cyclic redundancy code (CRC) scrambled via a group common radio network temporary identifier (RNTI)).

In some examples, an indication of a target Rx power level associated with a symbol/time-occasion may be indicated/defined via an association between the time-domain symbol/location and another time-domain symbol/location. The association may define the target Rx power level of a second symbol/time occasion, relative to the (previously known/defined) Rx power level of a first symbol/time occasion.

In some examples, preconfigured UL/SL occasions may comprise a first set of UL occasions associated with an HR receiver status, and a second set of UL occasions associated with an LR receiver status. For example, the target Rx power level associated with the UL/SL occasions may be defined only for the Rx with an LR status. As another example, upon receiving an indication for a corresponding target Rx power level associated with a transmission occasion, a UE may assume or determine the corresponding Rx with an LR status corresponding to the transmission occasion.

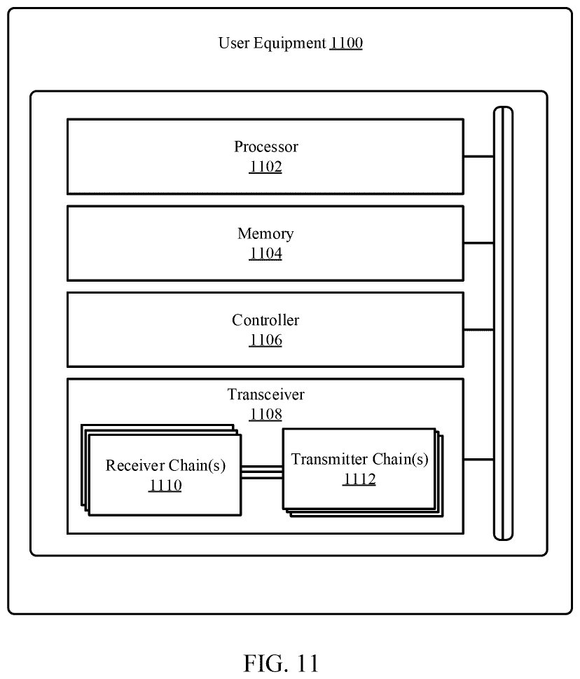

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to support a means for receiving a configuration for transmission to a receiver node, wherein the configuration includes: one or more parameters associated with determining a pathloss for the transmission, a set of transmission occasions at the receiver node, and an association of a corresponding Rx power level to each transmission occasion of the set of transmission occasions, identifying a transmission occasion of the set of transmission occasions, wherein the identified transmission occasion has a receiving Rx power level associated with a target Rx power level of the UE, and transmitting to the receiver node at the identified transmission occasion.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receive the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

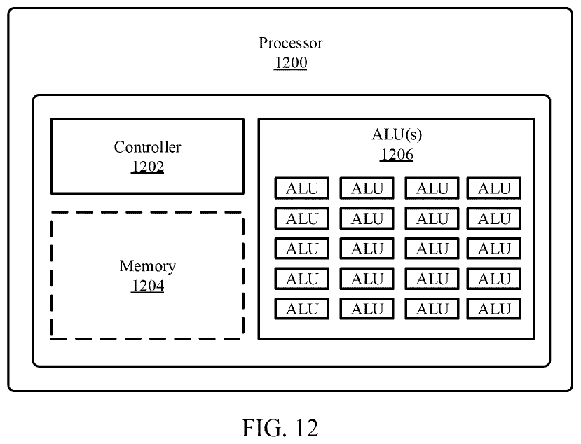

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to or operable to support a means for receiving a configuration for transmission to a receiver node, wherein the configuration includes: one or more parameters associated with determining a pathloss for the transmission, a set of transmission occasions at the receiver node, and an association of a corresponding Rx power level to each transmission occasion of the set of transmission occasions, identifying a transmission occasion of the set of transmission occasions, wherein the identified transmission occasion has a receiving Rx power level associated with a target Rx power level of the UE, and transmitting to the receiver node at the identified transmission occasion.

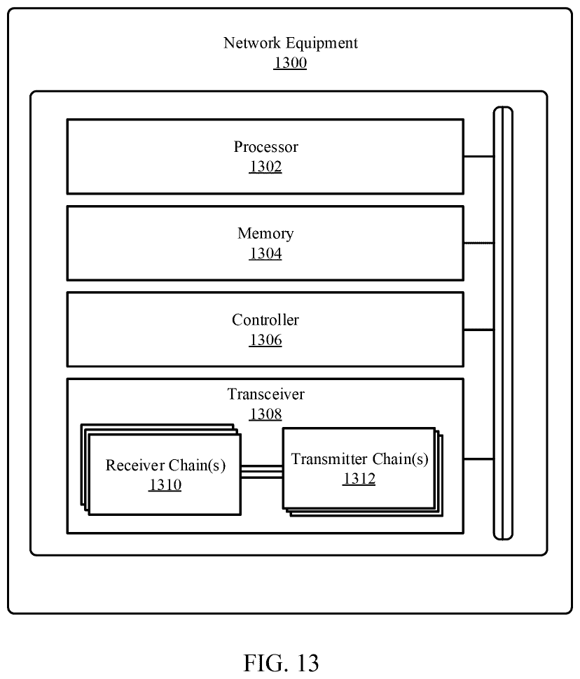

FIG. 13 illustrates an example of a NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein. The NE 1300 may be configured to support a means for transmitting, to a UE, a configuration for transmission to the network entity, wherein the configuration includes: one or more parameters associated with determining a pathloss for the transmission, a set of transmission occasions, and an association of a corresponding Rx power level to each transmission occasion of the set of transmission occasions, and receiving a preamble from the UE and via a transmission occasion having a receiving Rx power level that is associated with a target Rx power level of the UE.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas for receive the signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the processing the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

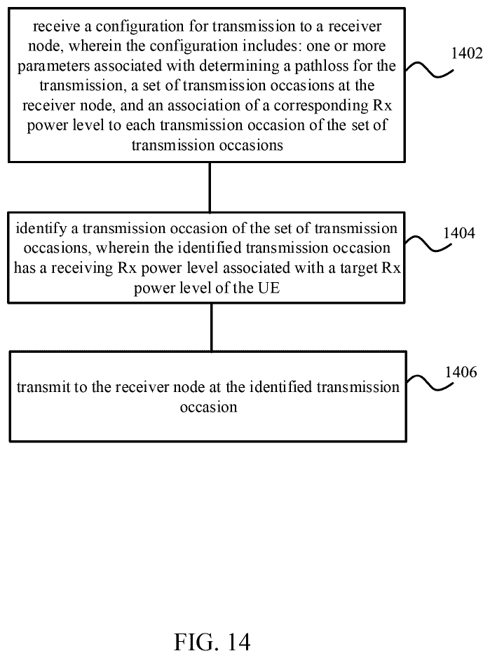

FIG. 14 illustrates a flowchart of a method in accordance with aspects of the present disclosure. The operations of the method may be implemented by a UE as described herein. In some implementations, the UE may execute a set of instructions to control the function elements of the UE to perform the described functions.

At 1402, the method may include receiving a configuration for transmission to a receiver node, wherein the configuration includes: one or more parameters associated with determining a pathloss for the transmission, a set of transmission occasions at the receiver node, and an association of a corresponding Rx power level to each transmission occasion of the set of transmission occasions. The operations of 1402 may be performed in accordance with examples as described herein. In some implementations, aspects of the operations of 1402 may be performed by a UE as described with reference to FIG. 11.

At 1404, the method may include identifying a transmission occasion of the set of transmission occasions, wherein the identified transmission occasion has a receiving Rx power level associated with a target Rx power level of the UE. The operations of 1404 may be performed in accordance with examples as described herein. In some implementations, aspects of the operations of 1404 may be performed a UE as described with reference to FIG. 11.

At 1406, the method may include transmitting to the receiver node at the identified transmission occasion. The operations of 1406 may be performed in accordance with examples as described herein. In some implementations, aspects of the operations of 1406 may be performed a UE as described with reference to FIG. 11.

It should be noted that the method described herein describes a possible implementation, and that the operations and the steps may be rearranged or otherwise modified and that other implementations are possible.

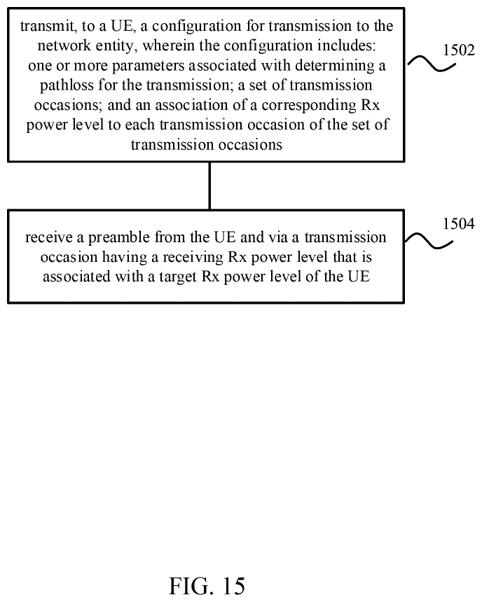

FIG. 15 illustrates a flowchart of a method in accordance with aspects of the present disclosure. The operations of the method may be implemented by an NE (e.g., a target RAN node) as described herein. In some implementations, the NE may execute a set of instructions to control the function elements of the NE to perform the described functions.

At 1502, the method may include transmitting, to a UE, a configuration for transmission to the network entity, wherein the configuration includes: one or more parameters associated with determining a pathloss for the transmission, a set of transmission occasions, and an association of a corresponding Rx power level to each transmission occasion of the set of transmission occasions. The operations of 1502 may be performed in accordance with examples as described herein. In some implementations, aspects of the operations of 1502 may be performed by an NE as described with reference to FIG. 13.

At 1504, the method may include receiving a preamble from the UE and via a transmission occasion having a receiving Rx power level that is associated with a target Rx power level of the UE. The operations of 1504 may be performed in accordance with examples as described herein. In some implementations, aspects of the operations of 1504 may be performed by an NE as described with reference to FIG. 13.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration for transmission to a receiver node, wherein the configuration includes:
one or more parameters associated with determining a pathloss for the transmission;
a set of transmission occasions at the receiver node; and
an association of a corresponding receiving (Rx) power level to each transmission occasion of the set of transmission occasions;
identify a transmission occasion of the set of transmission occasions,
wherein the identified transmission occasion has a receiving Rx power level associated with a target Rx power level of the UE; and
transmit to the receiver node at the identified transmission occasion.

2. The UE of claim 1, wherein the at least processor is configured to cause the UE to transmit a preamble to the receiving node via uplink (UL) physical random access channel (PRACH) at the identified transmission occasion.

3. The UE of claim 2, wherein the at least processor is configured to cause the UE to identify the transmission occasion based on its Rx power level, one or more supported Rx power levels of the UE, or a maximum transmitting (Tx) power level of the UE.

4. The UE of claim 1, wherein each transmission occasion of the set of transmission occasions is associated with a single power level, multiple power levels, or a ratio between two adjacent power levels of a power level sequence.

5. The UE of claim 1, wherein each transmission occasion of the set of transmission occasions is associated with a range of power levels.

6. The UE of claim 5, wherein a range of power levels is defined as a minimum starting power value, a maximum ending power value, a difference between two power values, or a group of power values within a grid of power level ranges.

7. The UE of claim 1, wherein the configuration includes:
an indication of one or more physical layer reference signals (PL-RSs);
an indication of a Tx power for the one or more PL-RSs;
an indication of the transmission occasions available at the receiving node;
an indication of transmission occasion parameters associated with low resolution (LR) status at the receiving node;
and combinations thereof.

8. The UE of claim 1, wherein the at least processor is configured to cause the UE to:
re-transmit to the receiving node using a Tx power used during the transmission to the receiving node at the identified transmission occasion;
re-transmit to the receiving node using a Tx power that is higher than a Tx power used during the transmission to the receiving node at the identified transmission occasion; or
re-transmit to the receiving node using a different transmission occasion.

9. The UE of claim 8, wherein the re-transmission is based on a number of previous failed transmissions to the receiving node.

10. The UE of claim 1, wherein the at least processor is configured to cause the UE to:
receive a synchronization signal block from the receiving node; and
determine an initial transmission occasion of the set of transmission occasions as a first transmission occasion of the set of transmission occasions.

11. The UE of claim 1, wherein the at least processor is configured to cause the UE to:
determine the pathloss for the transmission based on:
a number of beams at the receiving node;
a number of beams at the UE; and
a function that is based on multiple beam-pairs among the number of beams at the receiving node and the number of beams at the UE.

12. The UE of claim 11, wherein the pathloss is based on an average Rx power level of the beams at the receiving node.

13. The UE of claim 11, wherein the pathloss is based on a weighted average Rx power level of the beams at the receiving node.

14. The UE of claim 11, wherein the pathloss is based on a maximum Rx power level of the beams at the receiving node.

15. The UE of claim 1, wherein the set of transmission occasions is associated with frequency domain mapping of the identified transmission occasion and a frequency domain resource.

16. The UE of claim 1, wherein the identified transmission occasion is associated with a transmission occasion group and transmission occasion position.

17. A network entity for wireless communication, comprising:
at least one memory; and
at least one processor coupled with the at least one memory and configured to cause the network entity to:
transmit, to a user equipment (UE), a configuration for transmission to the network entity, wherein the configuration includes:
one or more parameters associated with determining a pathloss for the transmission;
a set of transmission occasions; and
an association of a corresponding receiving (Rx) power level to each transmission occasion of the set of transmission occasions; and
receive a preamble from the UE and via a transmission occasion having a receiving Rx power level that is associated with a target Rx power level of the UE.

18. The network entity of claim 17, wherein the at least one processor is further configured to cause the network entity to:
transmit, to the UE, an indication of a low resolution (LR) status for an Rx beam or antenna array,
wherein the LR status for the Rx beam or antenna array is indicated by:
the Rx beam or antenna array being associated with a radio chain having an LR analog-to-digital converter (ADC);
the Rx beam or antenna array being associated with an array of radio chains having LR ADCs; or
the Rx beam or antenna array having a reduced maximum achievable signal to noise ratio (SNR).

19. A method performed by a user equipment (UE), the method comprising:
receiving a configuration for transmission to a receiving node, wherein the configuration includes:
one or more parameters associated with determining a pathloss for the transmission;
a set of transmission occasions at the receiving node; and
an association of a corresponding receiving (Rx) power level to each transmission occasion of the set of transmission occasions;
identifying a transmission occasion of the set of transmission occasions,
wherein the identified transmission occasion has a receiving Rx power level associated with a target Rx power level of the UE; and
transmitting to the receiving node at the identified transmission occasion.

20. A method performed by a network entity, the method comprising:
transmitting, to a user equipment (UE), a configuration for transmission to the network entity, wherein the configuration includes:
one or more parameters associated with determining a pathloss for the transmission;
a set of transmission occasions; and
an association of a corresponding receiving (Rx) power level to each transmission occasion of the set of transmission occasions; and
receiving a preamble from the UE and via a transmission occasion having a receiving Rx power level that is associated with a target Rx power level of the UE.
